(19) United States
(12) Patent Application Publication
(10) Pub. No.: US 2025/0143324 A1
(43) Pub. Date: May 8, 2025

(54) USE OF A PLANT EXTRACT OF THE ASTERACEAE FAMILY AS A WOOD PROTECTION AND WOOD PEST CONTROL PRODUCT OR AS AN INSECTICIDE

(71) Applicant: BERKEM DEVELOPPEMENT, Blanquefort (FR)

(72) Inventors: Daouia MESSAOUDI, Saint-Priesst (FR); Olivier FAHY, Bordeaux (FR)

(21) Appl. No.: 18/721,789

(22) PCT Filed: Dec. 20, 2022
(86) PCT No.: PCT/FR2022/052451

§ 371 Date: Jan. 7, 2025

(30) Foreign Application Priority Data
Dec. 22, 2021 (FR) 2114267
Dec. 22, 2021 (FR) 2114268

(51) Int. Cl. A01N 65/12; A01N 25/04; A01N 65/08; A01N 65/22; A01P 3/00; A01P 7/04; A01P 17/00

(52) U.S. Cl. CPC A01N 65/12; A01N 25/04; A01N 65/08; A01N 65/22; A01P 3/00; A01P 7/04; A01P 17/00

(57) ABSTRACT

The present invention relates to the field of wood protection and wood pest control or as insecticide, and relates more particularly to the use of an extract of a plant and/or of the Asteraceae family, as a wood protection and wood pest control product or an insecticidal composition comprising an extract of a plant from the Asteraceae family.

### TECHNICAL FIELD

The present invention relates to the field of wood protection and wood pest control, and more particularly to the use of an extract of a plant from the Betulaceae family and/or the Asteraceae family and/or the Lamiaceae family, and even more particularly to the use of an extract of a plant from the Asteraceae family advantageously in combination with an extract of a plant from the Betulaceae family and/or the Lamiaceae family, as a wood protection and wood pest control product or as an insecticide.

### PRIOR ART

Xylophagous insects, larvae or fungi cause major damage to buildings by attacking the wood used in construction: framework, beams and floors. In extreme cases, the building may collapse.

Controlling xylophagous pests, and insects in general, currently relies essentially on the use of nonspecific chemical products, with risks that are now well known for both users and the environment.

Specifically, insect control products generally incorporate a bioactive agent having a preventive and/or curative action aimed at preventing and/or inhibiting the development and proliferation of these insects. These bioactive agents, which are pesticidal agents, must be used at the lowest possible concentration so as to reduce the harmful effects on non-target living organisms.

In this context, it is sought to use compositions containing one or more pesticidal substances with the harmlessness criteria established by European regulation (EU) No. 528/2012, following on from European directive 98/8/EC, and/or a pesticidal substance compatible with the harmlessness criteria established by European regulation (EU) No. 1107/2009, following on from European directive 91/414/EEC. To achieve this, the composition must contain as little pesticidal substance as possible, and the adjuvants used in combination with the pesticidal substance must not be toxic synthetic chemicals. In particular, the composition must be aimed at eradicating insects without being harmful to humans, non-target organisms or the environment.

Consequently, to be effective in the long term, the insect control must be based on the use of ecologically sound, safe and useful active principles. It is thus necessary to develop products to combat wood pests, in particular xylophagous insects, and more generally insecticides that are natural and effective.

### SUMMARY

According to one embodiment, the present invention thus relates to the use of an extract of a plant from the Betulaceae family and/or the Asteraceae family and/or the Lamiaceae family as a wood protection or wood pest control product.

According to one embodiment, the present invention relates to the use of an extract of a plant from the Asteraceae family as a wood protection or wood pest control product or as an insecticide. The extract of a plant from the Asteraceae family may advantageously be used in combination with an extract of a plant from the Betulaceae family and/or an extract of a plant from the Lamiaceae family.

Specifically, the inventors have advantageously demonstrated that extracts of hazelnut tree, oregano or arnica, alone or in combination, offer curative action against house capricorn beetle larvae (Hylotrupes bajulus). Extracts of hazelnut tree, oregano or arnica, alone or in combination, have also been shown to preserve wood from termite attack. Thus and advantageously, wood treated by impregnation with hazelnut tree, oregano or arnica extracts, alone or in combination, is termite-resistant.

According to another embodiment, the present invention also relates to wood protection and wood pest control products comprising an extract of a plant from the Betulaceae family and/or the Asteraceae family and/or the Lamiaceae family.

According to one embodiment, the present invention relates to wood protection and wood pest control products comprising an extract of a plant from the Asteraceae family. The product may also comprise an extract of a plant from the Betulaceae family and/or an extract of a plant from the Lamiaceae family.

According to another embodiment, the present invention also relates to a process for curative and/or preventive treatment of wood by means of a wood protection and wood pest control product, said product comprising a plant extract from the Betulaceae family and/or the Asteraceae family and/or the Lamiaceae family, said process comprising the step of applying said product to the wood to be treated and/or to a surface.

According to one embodiment, the present invention relates to a process for curative and/or preventive treatment of wood by means of a wood protection and wood pest control product, said product comprising an extract from the Asteraceae family, said process comprising the step of applying said product to the wood to be treated and/or to a surface. The product may also comprise an extract of a plant from the Betulaceae family and/or an extract of a plant from the Lamiaceae family.

According to one embodiment, the present invention relates to the use of an extract of a plant from the Betulaceae family and/or the Asteraceae family and/or the Lamiaceae family as an insecticide.

According to one embodiment, the present invention relates to the use of an extract of a plant from the Asteraceae family as an insecticide. The plant extract from the Asteraceae family may advantageously be used in combination with a plant extract from the Betulaceae family and/or a plant extract from the Lamiaceae family.

Specifically, the inventors have advantageously demonstrated that hazelnut tree, oregano or arnica extracts, alone or in combination, offer curative and repellent action against arthropods.

According to one embodiment, the present invention also relates to insect control products such as insecticidal and repellent compositions, the insecticidal and repellent compositions comprising an extract of a plant from the Betulaceae family and/or the Asteraceae family and/or the Lamiaceae family.

According to one embodiment, the present invention relates to insect control products such as insecticidal and repellent compositions, the insecticidal and repellent compositions comprising a plant extract from the Asteraceae family. The compositions may also comprise an extract of a plant from the Betulaceae family and/or an extract of a plant from the Lamiaceae family.

According to one embodiment, the present invention relates to a process for controlling insects by means of an insecticidal and/or repellent composition, said product comprising a plant extract from the Betulaceae family and/or the Asteraceae family and/or the Lamiaceae family, said process comprising the step of applying said compositions to a surface.

According to one embodiment, the present invention relates to a process for controlling insects by means of an insecticidal and/or repellent composition, said product comprising a plant extract from the Asteraceae family, said process comprising the step of applying said compositions to a surface. Said composition(s) may also comprise a plant extract of the Betulaceae family and/or a plant extract of the Lamiaceae family.

### DETAILED DESCRIPTION

According to one aspect, the present invention relates to the use of an extract of a plant from the Betulaceae family and/or the Asteraceae family and/or the Lamiaceae family as a wood protection or wood pest control product.

According to one embodiment, the present invention relates to the use of an extract of a plant from the Asteraceae family as a wood protection or wood pest control product. The plant extract of the Asteraceae family may advantageously be used in combination with a plant extract of the Betulaceae family and/or a plant extract of the Lamiaceae family.

### Wood Protection and Wood Pest Control Product

The term “wood protection product” or “wood pest control product” means any substance or mixture, consisting of one or more active substances, which is intended to destroy, repel or render harmless wood pests, to prevent their action or to combat them in any other manner by an action other than a simple physical or mechanical action.

Wood protection products will be applied to wood or wood products. Wood pest control products will be applied to surfaces not comprising wood.

The term “wood pest” means any organism whose presence is undesirable, which feeds on wood, and/or may attack any source of wood such as antique furniture, or structural elements in a building such as beams or framework.

Among the wood pests, mention may be made of xylophagous insects and xylophagous fungi.

Thus, according to one embodiment, the wood protection or wood pest control product is a wood protection or wood pest control product for combating xylophagous insects and/or xylophagous fungi.

Xylophagous insects feed on wood and may attack any type of wood, including furniture, floors, beams and framework. Their presence may jeopardize the structural elements of a home. Their action reduces the strength of wood, which becomes brittle and is no longer capable of fulfilling its role. These parasites have succeeded in developing an adaptability to their environment, and are capable of surviving in dry wood. Among xylophagous insects, mention may be made of termite genera such as Reticulitermes spp (the lucifugous termite (Reticulitermes lucifugus), the Saintonge termite (Reticulitermes santonensis or Reticulitermes flavipes)), yellow-necked termite (Kalotermes flavicollis)), Coptotermes spp, Prorhinotermes spp, Cryptotermes spp, Heterotermes spp, Nasusitermes spp, Macrotermes spp; Odontermes spp; Schedorhinotermes spp; Microtermes spp, Microcerotermes spp, Allodontermes spp, capricorn beetles such as Hylotrupes bajulus, Hymenoptera such as syrex, wood wasp and carpenter bee, carpenter ants, wood borers such as small whipworm, large whipworm, breadworm and bookworm, and lyctus beetles such as Lyctus brunneus and Lyctus linearus. Mention may also be made of fresh wood insects and hesperophanes.

During fruiting, fungi release considerable amounts of spores into the atmosphere. When a spore comes into contact with an exploitable substrate (wood, for example), it emits a filament that penetrates a wood cell, and then ends up colonizing the whole piece as it multiplies. Certain filaments may penetrate plaster and soft stone, and damage the structure of the building. There are three categories of fungi, depending on the nature of the damage they cause:
white or fibrous rot fungi, which are capable of digesting all the carbon compounds in wood (cellulose, hemicellulose and lignin); wood degraded in this way has a soft texture and is seen to be white in color. Mention may be made of the multicolored coloriole (Coriolus versicolor or Trametes versicolor) and the cellar polypore (Donkiporia);
brown rot fungi, which are incapable of digesting lignin. Wood degraded in this way is generally cubically segmented to a greater or lesser extent, and brown in color. Mention may be made of merula and its rhizomorphs (Serpula lacrymans), cellar coniophore (Coniophora puteana), Poria vaporaria, Poria spez, and oak lenzite. Mention may also be made of Gloeophyllum trabeum and Rhodonia placenta.
soft-rot microfungi, which also degrade only cellulose and hemicellulose, are found in areas in direct contact with the ground or vegetation, and are of less concern as regards dwellings.

Thus, among xylophagous fungi, mention may be made of the multicolored coloriole (Coriolus versicolor or Trametes versicolor), the cellar polypore (Donkiporia), merula and its rhizomorphs (Serpula lacrymans), the cellar coniophore (Coniophora puteana), Poria vaporaria, Poria spez, the oak lenzite, Gloeophyllum trabeum and Rhodonia placenta.

According to one embodiment, the xylophagous insects are chosen from Reticulitermes spp and capricorn beetles.

### Betulaceae, Asteraceae and Lamiaceae Families

The following plant species belong to these families: Corylus avellanna, Arnica montana and Origanum vulgare.

Thus, the present invention also relates to the use of Corylus avellanna and/or Arnica montana and/or Origanum vulgare as a wood protection or wood pest control product.

According to one aspect, the present invention also relates to the use of an extract of a plant from the Asteraceae family and/or the Betulaceae family and/or the Lamiaceae family as an insecticide.

According to one embodiment, the present invention relates to the use of an extract of a plant from the Asteraceae family as an insecticide. The plant extract from the Asteraceae family may advantageously be used in combination with a plant extract from the Betulaceae family and/or a plant extract from the Lamiaceae family.

### Insecticide

The term “insecticide” means any substance or mixture, consisting of one or more active substances, which is intended to destroy, repel or render harmless harmful insects, to prevent their action or to combat them in any other manner, by an action other than simple physical or mechanical action.

The term “pest insect” means any insect whose presence is undesirable or which produces a harmful effect on man, his activities or the products he uses or produces, or on animals or the environment.

Pest insects that may be mentioned include cockroaches such as the German cockroach or Blatella germanica, the Oriental cockroach or Blatta orientalis, the American cockroach or Periplaneta americana, the brown-banded cockroach or Supella longipalpa, ants such as the black garden ant or Lasius niger, the carpenter ant, the red or reddish ant, the pharaoh ant (Monomorium pharaonis), the Argentine ant, fleas or ctenocephalides, bedbugs such as Cimex lectularius, Cimex lectularius (resistant), wood bugs or Palomena prasina, woodlice (Porcellio scaber), silverfish or lepisma (Lepisma saccharina), flour beetle (Tribolium confusum), small whipworm (Alphitobius spp), yellow whipworm (Tenebrio molitor), carpet beetle (Anthrenus flavipes), spiders such as the garden spider (Araneus diadematus) or the long-legged spider (Pholcus spp.), lice such as the red poultry louse, wasps such as the western yellow jacket (Vespula pensylvanica), hornets, flies such as Musca domestica, Lucilia sericata, Stomoxys calcitrans, Drosophila melanogaster, bees, food moths such as the Indian flour moth (Plodia interpunctella), the Mediterranean flour moth (Ephestia kuehniella), clothes moths such as Tineola bisselliella, mosquitoes such as those of the genera Culex such as Culex quinquefasciatus, of the genus Anopheles such as Anopheles gambiae, of the genus Aedes, such as Aedes aegypti and Aedes albopictus, the rice weevil (Sitophilus oryzae), the spider mite (Rhizoperta dominica), the grain beetle (Sitophilus granarius), Sitophilus zeamais, the grain alucite (Sitotroga cerealella), Acarus siro, the fungus/fungi mite (Tyrophagus putrescentieae), grain beetle (Oryzaephilus surinamensis), flour worm (Tribolium castaneum, Tribolium confusum), Cryptolestes ferrugineus, Tenebroides mauritanicus, dried fruit moth or Indian dried fruit moth (Plodia interpunctella), flour moth (Ephestia kuehniella).

According to one embodiment, the insects are chosen from cockroaches, preferentially the American cockroach or Periplaneta americana, and mites, preferentially the poultry red mite.

### Extract of Hazelnut Tree (Corylus avellanna) CAS No. 84012-21-5

The hazelnut tree extract according to the present invention belongs to the genus Corylus and is preferentially an extract of the species Corylus avellanna.

Typically, the hazelnut tree extract may be obtained from the leaves, fruit (hazelnuts), bark, catkins or inflorescences.

Preferentially, the hazelnut tree extract is obtained from the leaves.

Preferentially, the hazelnut tree extract is obtained from the leaves of the Corylus avellanna species.

According to one embodiment, the hazelnut tree extract is manufactured from the leaves of the Corylus avellanna species and is obtained by a succession of extraction, filtration, purification and drying steps, known to those skilled in the art.

According to one embodiment, the hazelnut tree extract according to the invention is in solution in water or in at least one hydrophilic solvent, for instance linear or branched lower monoalcohols containing from 1 to 8 carbon atoms, such as ethanol, propanol, butanol, isopropanol, isobutanol; polyols such as propylene glycol, isoprene glycol, butylene glycol, propylene glycol, glycerol, sorbitol, polyethylene glycol and derivatives thereof, and mixtures thereof.

According to one embodiment, the hazelnut tree extract according to the invention is in solution in propylene glycol.

According to one embodiment, the hazelnut tree extract in solution is present in a content of between 0.01% and 10% by weight, relative to the total weight of the solution, preferentially between 0.5% and 5% by weight, relative to the total weight of the solution and in a preferred manner, the hazelnut tree extract may be present in the solution in a content of about 3% by weight relative to the total weight of the solution.

In the present invention, the term “about X %” means “X±1%”, preferably “X±0.5%”.

According to one embodiment, the hazelnut tree extract according to the invention is a hazelnut tree extract obtained according to a process comprising the following steps:
1. preparation of hazelnut tree (Corylus avellanna) leaves,
2. liquid/liquid (water/alcohol) extraction of the hazelnut tree leaves to obtain a hazelnut tree extract,
3. optionally, co-concentration of the hazelnut tree extract in propylene glycol, to obtain the hazelnut tree extract in solution in propylene glycol, preferably at a content of between 0.01% and 10% by weight, preferably between 0.5% and 5% by weight, preferably at a content of about 3% by weight of hazelnut tree extract relative to the total weight of the solution.

### Extract of Arnica (Arnica montana) CAS No. 68990-11-4

The arnica extract according to the present invention belongs to the Arnica genus and is preferentially an extract of the Arnica montana species.

Typically, the arnica extract may be obtained from the flower, leaves, stems, roots and seeds.

Preferentially, the arnica extract is obtained from the flowers.

Preferentially, the arnica extract is obtained from the flowers of the Arnica montana species.

According to one embodiment, the arnica extract is manufactured from the flowers of the Arnica montana species and is obtained by a succession of extraction, filtration, purification and drying steps, known to those skilled in the art.

According to one embodiment, the sesquiterpene lactone ester content is preferentially less than 1%, and preferentially less than 0.2% of the extract. This constituent may be quantified by any method known to those skilled in the art, for example by reverse-phase high-performance liquid chromatography with ultraviolet absorption detection.

According to one embodiment, the arnica extract according to the invention is in solution in water or in at least one hydrophilic solvent, for instance linear or branched lower monoalcohols containing from 1 to 8 carbon atoms, such as ethanol, propanol, butanol, isopropanol, isobutanol; polyols such as propylene glycol, isoprene glycol, butylene glycol, propylene glycol, glycerol, sorbitol, polyethylene glycol and derivatives thereof, and mixtures thereof.

According to one embodiment, the arnica extract according to the invention is dissolved in propylene glycol.

According to one embodiment, the arnica extract in solution is present in a content of between 0.01% and 10% by weight, relative to the total weight of the solution, preferentially between 2% and 8% by weight, relative to the total weight of the solution, and in a preferred manner, the arnica extract is present in the solution in a content of about 5% by weight, relative to the total weight of the solution.

Typically, the arnica extract according to the invention is in solution in propylene glycol, the arnica extract content being about 5% relative to the total weight of the solution.

According to one embodiment, the arnica extract according to the invention is an arnica extract obtained according to a process comprising the following steps:
1. preparation of arnica (Arnica montana) flowers,
2. liquid/liquid (water/alcohol) extraction to obtain an arnica extract,
3. optionally, co-concentration of the arnica extract in propylene glycol to obtain the arnica extract in solution in propylene glycol, preferably at a content of between 0.01% and 10% by weight, preferably between 2% and 8% by weight, preferably at a content of about 5% by weight of arnica extract relative to the total weight of the solution.

### Extract of Oregano (Origanum vulgare)

The oregano extract according to the present invention belongs to the Origanum genus and is preferentially an extract of the Origanum vulgare species.

Typically, the oregano extract may be obtained from dried leaves or flowering tops.

Preferentially, the oregano extract is obtained from the leaves.

Preferentially, the oregano extract is obtained from the leaves of the Origanum vulgare species.

According to one embodiment, the oregano extract is manufactured from the leaves of the Origanum vulgare species and is obtained by a succession of extraction, filtration, purification and drying steps, known to those skilled in the art.

According to one embodiment, the oregano extract according to the invention is in solution in water or in at least one hydrophilic solvent, for instance linear or branched lower monoalcohols containing from 1 to 8 carbon atoms, such as ethanol, propanol, butanol, isopropanol, isobutanol; polyols such as propylene glycol, isoprene glycol, butylene glycol, propylene glycol, glycerol, sorbitol, polyethylene glycol and derivatives thereof, and mixtures thereof.

According to one embodiment, the oregano extract according to the invention is dissolved in propylene glycol.

According to one embodiment, the oregano extract in solution is present in a content of between 0.01% and 20% by weight, relative to the total weight of the solution, preferentially between 9% and 15% by weight, relative to the total weight of the solution and in a preferred manner, the oregano extract may be present in the solution in a content of about 10% by weight relative to the total weight of the solution.

According to one embodiment, the oregano extract according to the invention is an oregano extract obtained according to a process comprising the following steps:
1. preparation of oregano (Origanum vulgare) leaves,
2. liquid/liquid (water/alcohol) extraction to obtain an oregano extract,
3. optionally, co-concentration of the oregano extract in propylene glycol to obtain the oregano extract in solution in propylene glycol, preferably at a content of between 0.01% and 20% by weight, preferably between 9% and 15% by weight, preferably at a content of about 10% by weight of oregano extract relative to the total weight of the solution.

### Wood Protection or Wood Pest Control Products

According to another aspect, the present invention also relates to wood protection or wood pest control products.

According to European Regulation (EU) No. 528/2012, wood protection (or preservation) products are products used to protect wood or wood products, through the control of organisms that destroy or deform wood, including insects. This type of product comprises both preventive and curative treatment products. Wood protection (or preservation) products are applied to wood or wood products.

Wood pest control products also relate to products used to protect wood or wood products by controlling organisms that destroy or deform wood, including insects. Wood pest control products are not, however, applied to the wood or wood product but to any other surface, so as to protect or treat the wood or wood product. This type of product also comprises preventive and curative treatment products.

The term “wood or wood product” means any wood or material based on or comprising wood. By way of illustration, mention may be made of wood from sawmills, including during the processing phase in the sawmill, logs, frameworks, beams, building materials, furniture, cladding, wood-fiber-based materials, OSB (oriented strand board), plywood, interior joisting, decking, exterior fittings, ground stakes and retaining walls, parquet flooring, and interior coverings made from wood material.

The term “surface” means any surface other than wood or a wood product. Typically, the product may be applied in load-bearing walls, partitions, party walls and lined walls and/or on the ground to provide a continuous chemical barrier in the soil surrounding and/or beneath a structure (residential, industrial or agricultural), on the perimeter and bottom of foundations, on the perimeter and bottom of excavations, in trenches, in voids, cracks, crevices, crawl spaces, hard-to-reach areas, basements and the like.

According to one embodiment, the wood protection or wood pest control product comprises a hazelnut tree extract, said hazelnut tree extract being present in the product in a content of between 0.1% and 5% by weight, relative to the total weight of the product, preferentially between 0.1% and 3% by weight, relative to the total weight of the product, and preferably at about 2% by weight, relative to the total weight of the product.

According to one embodiment, the wood protection or wood pest control product comprises an arnica extract, said arnica extract being present in the product in a content of between 0.1% and 5% by weight, relative to the total weight of the product, preferentially between 0.1% and 3% by weight, relative to the total weight of the product, and preferably at about 2% by weight, relative to the total weight of the product.

According to one embodiment, the wood protection or wood pest control product comprises an arnica extract and a hazelnut tree extract, said extracts being present in the product in a content of between 0.1% and 5% by weight, relative to the total weight of the product, preferentially between 0.1% and 3% by weight, relative to the total weight of the product, and preferably at about 2% by weight, relative to the total weight of the product.

According to one embodiment, the wood protection or wood pest control product also comprises an oregano extract, said oregano extract being present in the product in a content of between 0.1% and 10% by weight, relative to the total weight of the product, preferentially between 1% and 5% by weight, relative to the total weight of the product, and preferably at about 3.5% by weight, relative to the total weight of the product.

The wood protection or wood pest control products may be in any form commonly used in this field, such as gels, aerosols, aqueous, aqueous-alcoholic or oily solutions, solvent-based solutions, anhydrous compositions, oil-in-water or water-in-oil emulsions, microemulsions, nanoemulsions, solid pellets, or dispersible powders/granules.

According to one embodiment, the wood protection or wood pest control products described above may also comprise at least one additional agent chosen from nonionic surfactants, antifoams, anionic surfactants, water-soluble polymers, chelating agents, acids, preserving agents, waxes, waxy emulsions, cationic surfactants, insecticides, plant extracts, antioxidants, fungicides, cellulose ethers, isoalkanes, a mixture of alkoxysilane and disiloxane, luminescent agents, UV stabilizers, tagging agents, biobased cosolvents such as those in the Augeo® range sold by the company Solvay and those in the Isane Biolife® range sold by the company Total Energies.

Among the nonionic surfactants, mention may be made of ethoxylated alcohols, ethoxylated oils, alkylpolyglucosides, ethoxylated ammoniums, low-foaming nonionic surfactants, polyalkylene glycols and block copolymers.

Among the anionic surfactants, mention may be made of fatty alcohol ether sulfates, fatty alcohol sulfates and linear alkyl benzene sulfonates.

Among the water-soluble polymers, mention may be made of dispersants and thickeners.

Among the chelating agents, mention may be made of ethylenediaminetetraacetic acid (EDTA), the tetrasodium salt of N,N-dicarboxymethylglutamic acid (GLDA), diethylenetriaminepentaacetic acid (DTPA), (2-hydroxyethyl) ethylenediaminetriacetic acid (HEDTA), nitrilotriacetic acid (NTA), propylenediaminetetraacetic acid (PDTA), ethanol glycine (EDG), glucoheptonate, sodium gluconate, gluconic acid, etc.

Among the preserving agents, mention may be made of Bronopol, formic acid, glutaraldehyde, glyoxal, n-propanol, phenoxyethanol and dichlorohydroxydiphenyl ether (DCPP).

Among the insecticides, mention may be made of thiacloprid, cypermethrin, permethrin, diflubenzuron, bifenthrin, deltamethrin, imiprothrin, D-allethrin, piperonyl butoxide, geraniol, D-tetramethrin, pepper extract, esbiothrin, prallethrin, chlorfenapyr, cyanamide, chrysantheum and a mixture thereof, and microorganisms.

Among the fungicides, mention may be made of the triazole family such as propiconazole, tebuconazole, cyproconazole, 3-iodo-2-propynyl butylcarbamate (IPBC), penfluflen, fenpropimorph, quaternary ammoniums and quaternary ammonium salts such as alkyldimethylbenzylammonium chloride (ADBAC, BKC), tetramethylammonium cation (TMAC), N-(3-aminopropyl)-N-dodecylpropane-1,3-diamine (diamine), N,N-didecyl-N-methylpoly(oxyethyl)ammonium propionate (Bardap26), didecyldimethylammonium chloride (DDAC) and microorganisms.

Among the plant extracts, mention may be made of grape (Vitis vinifera L) seed extract, pine (Pinus pinaster) bark extract, and peanut (Arachis hypogaea) extract.

Among the cellulose ethers, mention may be made of methyl cellulose, ethyl cellulose, hydroxyethyl cellulose, modified hydroxyethyl cellulose, hydroxypropyl cellulose, hydroxyethyl methyl cellulose, hydroxypropyl methyl cellulose and carboxymethyl cellulose.

Among the isoalkanes, mention may be made of C8-C18 isoalkanes (also known as isoparaffins) such as C11-C12 isoalkane, C11-C13 isoalkane, C15-C18 isoalkane, C15-C16 isoalkane, C17-C18 isoalkane, C17-C18 isoalkane or mixtures thereof. Typically, the renewable isoalkanes in the Biolife range from the company Total Energies may be used.

These ingredients are preferentially biobased.

According to one embodiment, the wood protection or wood pest control products are in the form of gels.

For the purposes of the present patent application the term “gel” means a composition with a viscosity of between 50 000 cP and 2 400 000 cP, preferentially between 700 000 cP and 2 400 000 cP at room temperature.

The viscosity may be measured using any viscometer and via any method known to those skilled in the art.

Typically, the viscosity of the composition may be measured using any Brookfield analog viscometer. By way of illustration, the viscosity was measured at room temperature, using a Brookfield analog viscometer, with a rotor 6, at a speed of 0.3 rpm.

The viscosity measurement is performed on the sample which has remained at room temperature.

According to a preferred embodiment, the biocidal composition according to the invention is in the form of an aqueous gel.

According to one embodiment, the wood protection or wood pest control products will be in the form of an aqueous gel and comprise at least one isoalkane, at least one cellulose ester, at least one plant extract from the Betulaceae family and/or the Asteraceae family and/or the Lamiaceae family, at least one mixture of alkoxysilane and disiloxane and water.

### Process for the Curative and/or Preventive Treatment of Wood

According to another aspect, the present invention relates to a curative and/or preventive treatment process for wood protection or wood pest control by means of a wood protection or wood pest control product, said product comprising at least one plant extract from the Betulaceae family and/or the Asteraceae family and/or the Lamiaceae family, said process comprising the step consisting in applying said product to the wood to be treated and/or to a surface.

According to one embodiment, the present invention relates to a curative and/or preventive treatment process for wood protection or wood pest control by means of a wood protection or wood pest control product, said product comprising at least one plant extract from the Asteraceae family, said process comprising the step of applying said product to the wood to be treated and/or to a surface. The product may also comprise an extract of the Betulaceae family and/or a plant extract of the Lamiaceae family.

According to one embodiment, the curative and/or preventive treatment process is a curative and/or preventive wood protection treatment using a wood protection product, said product comprising at least one plant extract from the Betulaceae family and/or the Asteraceae family and/or the Lamiaceae family, said process comprising the step of applying said product to the wood to be treated.

According to one embodiment, the curative and/or preventive treatment process is a curative and/or preventive wood protection treatment using a wood protection product, said product comprising at least one extract of a plant from the Asteraceae family, said process comprising the step of applying said product to the wood to be treated. The product may also comprise a plant extract of the Betulaceae family and/or of the Lamiaceae family.

According to one embodiment, the curative and/or preventive treatment process is a curative and/or preventive wood pest control treatment using a wood pest control product, said product comprising at least one plant extract from the Betulaceae family and/or the Asteraceae family and/or the Lamiaceae family, said process comprising the step of applying said product to a surface.

According to one embodiment, the curative and/or preventive treatment process is a curative and/or preventive wood pest control treatment using a wood pest control product, said product comprising at least one extract of a plant from the Asteraceae family, said process comprising the step of applying said product to a surface. The product may also comprise a plant extract of the Betulaceae family and/or of the Lamiaceae family.

Typically, the extract will be chosen from the species Corylus avellanna or Arnica montana or Origanum vulgare.

The term “preventive treatment” means any treatment that prevents healthy wood from being infected with wood degradation agents such as wood pests (xylophagous insects and xylophagous fungi). Preventive treatment comprises temporary treatment of logs, treatment of fresh sawn timber, anti-bluing treatment in service, treatment according to wood use classes in Europe and according to hazard classes in other parts of the world (USA, Australia, etc.), and treatment of structural panels. Within the use classes, a distinction is made between indoor and outdoor uses of wood (above ground, in the ground).

In addition to preventive treatment of wood by application of the product to the wood, an insecticidal or fungicidal barrier may be used to isolate wood pests from access to the building containing the wood. This is known as wood pest control. This system is generally installed between the ground and the building to keep wood pests out and eliminate those that come into contact with the insecticide or fungicide. This preventive treatment relates to both new and existing buildings (residential, industrial or agricultural).

The term “curative treatment” refers to any treatment aimed at destroying or rendering harmless wood pests, or at least improving the condition. Curative treatment means, for example, the treatment of an infestation of wood pests such as termites, and comprises the destruction of these pests or at least arresting the development or regression of the infestation. This curative treatment relates to the wood that is used, but also to existing constructions.

According to one embodiment, the application will be performed by sprinkling, flow-coating, dipping, brushing, injection, manual injection, aerosol, spraying, vaporization, impregnation, deep impregnation by double-vacuum or vacuum and pressure autoclave.

According to one embodiment, in the context of a curative treatment, the application will preferentially be performed by injection, spraying, vaporization or brushing.

According to one embodiment, in the context of a preventive treatment, the application will preferentially be performed by sprinkling, flow-coating, dipping, brushing, impregnation, or deep impregnation by double-vacuum or vacuum and pressure autoclave.

According to one embodiment, in the context of a preventive or curative treatment of furniture, the application will be performed preferentially by brushing, manual injection, aerosol or spraying.

In the case of application to the ground, three common methods of applying wood protection or wood pest control products to floors are broadcast spraying, under-slab injection and trenching. A generalized low-pressure sprayer may be used to apply the wood protection or pest control product as a preconstruction treatment before slabs are poured, or as a preconstruction treatment for inaccessible crawl spaces, or as a post-construction treatment coupled with wall injection.

Thus, and according to one embodiment, the present invention relates to a process for the preventive treatment of buildings by means of a wood pest control product, said product comprising at least one plant extract from the Betulaceae family and/or the Asteraceae family and/or the Lamiaceae family, said process comprising the step of applying said product by broadcast spraying, under-slab injection or by trenching.

According to one embodiment, the present invention relates to a process for the preventive treatment of buildings by means of a wood pest control product, said product comprising at least one plant extract from the Asteraceae family, said process comprising the step of applying said product by broadcast spraying, under-slab injection or trenching. The product may also comprise a plant extract of the Betulaceae family and/or an extract of the Lamiaceae family.

According to another embodiment, a film may be impregnated with a wood pest control product.

Thus, according to another embodiment, the present invention relates to a process for the preventive treatment of buildings by means of a wood pest control product, said product comprising at least one plant extract from the Betulaceae family and/or the Asteraceae family and/or the Lamiaceae family, said process comprising the step of applying said product on film and depositing said film on a surface.

According to one embodiment, the present invention relates to a process for the preventive treatment of buildings by means of a wood pest control product, said product comprising at least one plant extract from the Asteraceae family, said process comprising the step of applying said product on film and depositing said film on a surface. The product may also comprise a plant extract of the Betulaceae family and/or of the Lamiaceae family.

Typically, the film may be a polymer material film.

Typically, the film will be impregnated with one or more extracts according to the invention and will be applied, for example, to the perimeter and bottom of excavations, or to the perimeter or foundations of a house, in such a way as to act as a physicochemical barrier against termites.

According to another embodiment, the wood pest control product may be integrated into a wood pest trap or a connected object.

A person skilled in the art will be familiar with these treatments and will know how to apply them according to the desired application.

The wood protection and wood pest control products are as described above.

### Pest Control Products Such as Insecticides and Repellents

According to one aspect, the present invention also relates to pest control products such as insecticides and repellents.

According to European Regulation (EU) No. 528/2012, insecticidal compositions are used to control arthropods such as insects, by means other than repelling or attracting them.

According to European Regulation (EU) No. 528/2012, repellents and baits mean products used to control pests by repelling or attracting them, including products used, for human or veterinary hygiene, directly on the skin or indirectly in the environment of humans or animals.

According to one embodiment, the present invention relates to an insecticidal composition comprising an extract of arnica or an extract of hazelnut tree or a mixture thereof, said extract of arnica or extract of hazelnut tree or a mixture thereof being present in the composition in a content of between 0.1% and 5% by weight, relative to the total weight of the composition, preferentially between 0.1% and 3% by weight, relative to the total weight of the composition and preferably at about 2% by weight, relative to the total weight of the composition.

According to one embodiment, the present invention relates to a repellent composition comprising an extract of arnica or an extract of hazelnut tree or a mixture thereof, said extract of arnica or extract of hazelnut tree or a mixture thereof being present in the composition in a content of between 0.1% and 5% by weight, relative to the total weight of the composition, preferentially between 0.1% and 3% by weight, relative to the total weight of the composition and preferably at about 2% by weight, relative to the total weight of the composition.

According to one embodiment, the insecticidal or repellent composition also comprises an extract of oregano, said oregano extract being present in the composition in a content of between 0.1% and 10% by weight, relative to the total weight of the composition, preferentially between 1% and 5% by weight, relative to the total weight of the composition, and preferably at about 3.5% by weight, relative to the total weight of the composition.

According to one embodiment, the insecticidal or repellent compositions described above may also comprise at least one additional agent chosen from nonionic surfactants, antifoams, anionic surfactants, water-soluble polymers, chelating agents, acids, preserving agents, waxes, waxy emulsions, cationic surfactants and insecticides, plant extracts, antioxidants, fungicides, cellulose ethers, isoalkanes, a mixture of alkoxysilane and disiloxane, luminescent agents, UV stabilizers, tagging agents, biobased cosolvents such as those in the Augeo® range sold by the company Solvay and those in the Isane Biolife® range sold by the company Total Energies.

Among the nonionic surfactants, mention may be made of ethoxylated alcohols, ethoxylated oils, alkylpolyglucosides, ethoxylated ammoniums, low-foaming nonionic surfactants, polyalkylene glycols and block copolymers.

Among the anionic surfactants, mention may be made of fatty alcohol ether sulfates, fatty alcohol sulfates and linear alkyl benzene sulfonates.

Among the water-soluble polymers, mention may be made of dispersants and thickeners.

Among the chelating agents, mention may be made of ethylenediaminetetraacetic acid (EDTA), the tetrasodium salt of N,N-dicarboxymethylglutamic acid (GLDA), diethylenetriaminepentaacetic acid (DTPA), (2-hydroxyethyl)ethylenediaminetriacetic acid (HEDTA), nitrilotriacetic acid (NTA), propylenediaminetetraacetic acid (PDTA), ethanol glycine (EDG), glucoheptonate, sodium gluconate, gluconic acid, etc.

Among the preserving agents, mention may be made of Bronopol, formic acid, glutaraldehyde, glyoxal, n-propanol, phenoxyethanol and dichlorohydroxydiphenyl ether (DCPP).

Among the insecticides, mention may be made of thiacloprid, cypermethrin, permethrin, diflubenzuron, bifenthrin, deltamethrin, imiprothrin, D-allethrin, piperonyl butoxide, geraniol, D-tetramethrin, pepper extract, esbiothrin, prallethrin, chlorfenapyr, cyanamide, chrysantheum and a mixture thereof, and microorganisms.

Among the fungicides, mention may be made of the triazole family such as propiconazole, tebuconazole, cyproconazole, 3-iodo-2-propynyl butylcarbamate (IPBC), penfluflen, fenpropimorph, quaternary ammoniums and quaternary ammonium salts such as alkyldimethylbenzylammonium chloride (ADBAC, BKC), tetramethylammonium cation (TMAC), N-(3-aminopropyl)-N-dodecylpropane-1,3-diamine (diamine), N,N-didecyl-N-methylpoly(oxyethyl)ammonium propionate (Bardap26), didecyldimethylammonium chloride (DDAC) and microorganisms.

Among the plant extracts, mention may be made of grape (Vitis vinifera L) seed extract, pine (Pinus pinaster) bark extract, and peanut (Arachis hypogaea) extract.

Among the plant extracts, mention may be made of grape (Vitis vinifera L) seed extract, pine (Pinus pinaster) bark extract, and peanut (Arachis hypogaea) extract.

Among the cellulose ethers, mention may be made of methyl cellulose, ethyl cellulose, hydroxyethyl cellulose, modified hydroxyethyl cellulose, hydroxypropyl cellulose, hydroxyethyl methyl cellulose, hydroxypropyl methyl cellulose and carboxymethyl cellulose.

Among the isoalkanes, mention may be made of C8-C18 isoalkanes (also known as isoparaffins) such as C11-C12 isoalkane, C11-C13 isoalkane, C15-C18 isoalkane, C15-C16 isoalkane, C17-C18 isoalkane, C17-C18 isoalkane or mixtures thereof. Typically, the renewable isoalkanes in the Biolife range from the company Total Energies may be used.

These ingredients are preferentially biobased.

The pest control products may be in any form commonly used in this field, such as gels, aerosols, aqueous, aqueous-alcoholic or oily solutions, anhydrous compositions, oil-in-water or water-in-oil emulsions.

According to one embodiment, the pest control products are in the form of aerosols or gels.

For the purposes of the present patent application the term “gel” means a composition with a viscosity of between 50 000 cP and 2 400 000 cP, preferentially between 700 000 cP and 2 400 000 cP at room temperature.

The viscosity may be measured using any viscometer and via any method known to those skilled in the art.

Typically, the viscosity of the composition may be measured using any Brookfield analog viscometer. By way of illustration, the viscosity was measured at room temperature, using a Brookfield analog viscometer, with a rotor 6, at a speed of 0.3 rpm.

The viscosity measurement is performed on the sample which has remained at room temperature.

According to a preferred embodiment, the biocidal composition according to the invention is in the form of an aqueous gel.

According to one embodiment, the insecticidal or repellent compositions will be in the form of an aqueous gel and comprise at least one isoalkane, at least one cellulose ester, at least one plant extract from the Betulaceae family and/or the Asteraceae family and/or the Lamiaceae family, at least one mixture of alkoxysilane and disiloxane and water.

According to one embodiment, the insecticidal or repellent compositions will be in the form of an aqueous gel and comprise at least one isoalkane, at least one cellulose ester, at least one plant extract from the Asteraceae family, at least one mixture of alkoxysilane and disiloxane and water. The compositions may also comprise an extract of a plant from the Betulaceae family and/or from the Lamiaceae family.

### Pest Control Process

According to one aspect, the present invention relates to a process for controlling pests by means of an insecticidal composition and/or a repellent composition, said composition(s) comprising at least one plant extract from the Betulaceae family and/or the Asteraceae family and/or the Lamiaceae family, said process comprising the step consisting in applying said composition(s) to the surface to be treated.

According to one embodiment, the present invention relates to a process for controlling pests by means of an insecticidal composition and/or a repellent composition, said composition(s) comprising at least one plant extract from the Asteraceae family, said process comprising the step consisting in applying said composition(s) to the surface to be treated. Said composition(s) may also comprise an extract of a plant from the Betulaceae family and/or the Lamiaceae family.

Typically, the extract will be chosen from the species Corylus avellanna or Arnica montana or Origanum vulgare.

Typically, application is performed by dipping, brushing, injection, spraying, vaporization or impregnation.

The surface to be treated is understood in a broad manner and applies, in the case of an insecticidal composition, to any surface comprising at least one pest insect. By way of illustration, mention may be made of the surface of a ground, the surface of a piece of furniture, the surface of a material, the surface of a work surface, a window frame, but also the surface of the skin of a human being or an animal, the surface of a textile, the surface of household linen, etc.

Preferentially, application will be performed by spraying or vaporizing the compositions described, in the form of an aerosol.

A person skilled in the art will be familiar with these treatments and will know how to apply them according to the desired application.

By way of illustration, the insecticidal compositions may be applied by means of an aerosol, lasting about 2 seconds, at a distance of 60 centimeters from the insects.

In the context of a repellent composition, the term “surface” is also to be understood in a broad manner and applies to any surface on which pest insects are liable to be present. By way of illustration, mention may be made of the surface of a ground, the surface of a piece of furniture, a material, a work surface, a window frame, but also the surface of the skin of a human being or animal, the surface of a textile, the surface of household linen, etc.

The pest control process means agricultural use (treatment of crops, foodstuffs (storage, transport), harvests) and non-agricultural use.

Thus, surfaces may also be crops, harvests, foodstuffs, gardens, etc.

### EXAMPLES

### Example 1: Determination of the Curative Action Against Hylotrupes bajulus (Linnaeus) Larvae of Extracts According to the Invention—Wood Protection

In this example, the curative action of extracts according to the invention was studied according to the criteria of the standard NF EN 1390/2006. This standard describes a laboratory test method that provides a basis for assessing the curative action of fast-acting or slow-acting wood protection products and delayed-acting wood protection products against Hylotrupes bajulus (Linnaeus). It enables determination of the lethal effect of a protection product deposited by surface application on a population of larvae already installed in the test specimens.

### Materials and Methods According to the Standard EN 1390/2006-09

### Principle

Hylotrupes bajulus larvae are introduced into the test specimens. After a period intended to allow the larvae to become established in the test specimens, the test specimens are treated by brushing with or pipetting in the protection product under test. After a period defined according to the speed of action of the wood protection product, the mortality of the larvae is estimated by comparison with that of the larvae in the untreated control specimens.

### Hylotrupes bajulus (Linnaeus) Larvae

Larvae are obtained according to the rearing method for Hylotrupes bajulus (Linnaeus) described in Annex B of the standard NF EN 1390/2006.

### Wood Species

The reference species is Scots pine (Pinus sylvestris Linnaeus).

The larvae, products and reagents, equipment, test specimens, test procedure and test duration are those described in the standard NF EN 1390/2006.

The results are expressed as the mean percentage of mortality in treated test specimens and in untreated control specimens.

### Arnica Extract

A sustained-release formulation was used in this example. The formulation is an aqueous composition comprising an isoalkane, a cellulose ether and hazelnut tree or arnica extract. The formulation comprises 2%, relative to the total weight of the composition, of hazelnut tree or arnica extract, between 10% and 40%, relative to the total weight of the composition of an isoalkane and between 0.5% and 2%, relative to the total weight of the composition, of a cellulose ether.

### Results

### Arnica Extract

Treatment method: application by brush
Average amount of arnica extract applied to each test specimen: about 300 ml/m²)

TABLE 1

| | Retention | | | Larvae | | % |
|---|---|---|---|---|---|---|
| | by test | Insects found | | (dead/ | Larvae | Mor- |
| Treatment | specimen | Coleoptera | Larvae | dying) | (live) | tality |
| (ml/m²) | g/m² | Total | Total | Total | Total | Total |
| 0 (control) | 0 | 3 | 6 | 1 | 5 | 11.1 |
| Arnica | 270 | 0 | 60 | 59 | 1 | 98.3 |
| extract | | | | | | |
| (300 | | | | | | |
| ml/m²) | | | | | | |

Determination of the efficacy of the arnica extract against Hylotrupes bajulus larvae

According to the criteria of the standard NF EN 1390/2006, the arnica extract according to the invention eradicates Hylotrupes bajulus larvae, compared with the control. The mortality rate is 98.3%.

### Extract of Hazelnut Tree

Treatment method: application by brush
Average amount of hazelnut tree extract applied to each test specimen: about 300 ml/m²

TABLE 2

| | Retention | | | Larvae | | % |
|---|---|---|---|---|---|---|
| | by test | Insects found | | (dead/ | Larvae | Mor- |
| Treatment | specimen | Coleoptera | Larvae | dying) | (live) | tality |
| (ml/m²) | g/m² | Total | Total | Total | Total | Total |
| 0 (control) | 0 | 3 | 4 | 1 | 4 | 8.3 |
| Arnica | 285 | 0 | 59 | 59 | 0 | 100 |
| extract | | | | | | |
| (300 | | | | | | |
| ml/m²) | | | | | | |

Determination of the efficacy of the hazelnut tree extract against Hylotrupes bajulus larvae

According to the criteria of the standard NF EN 1390/2006, the hazelnut tree extract according to the invention eradicates Hylotrupes bajulus larvae, compared with the control. The mortality rate is 100%.

The curative action of arnica and hazelnut tree extracts against Hylotrupes bajulus larvae is in accordance with the requirements of the standard NF EN 1390/2006.

### Example 2: Bait Comprising Extracts of Hazelnut Tree, Arnica and Oregano According to the Invention—Determination of the Wood Protection Action of Extracts According to the Invention Against Coptotermes acinaciformis

The object of the present example is to evaluate the attractiveness and effect on a termite population of a bait and thus to determine whether the extracts according to the invention have a wood protection action against Coptotermes acinaciformis. Several series of test specimens of wood from a susceptible species were impregnated with a series of solutions. These test specimens were then exposed to specific termite colonies, and the attack suffered by these wood test specimens was determined. The results obtained are compared with control specimens.

The three extracts are dissolved in propylene glycol in the proportions 1/3,1/3,1/3.

### Materials and Methods

The evaluation took place in a dry sclerophyllous forest of native eucalyptus. The forest contains numerous mounds of Coptotermes acinaciformis, a subterranean termite.

### “Lunch Box” Technique

The “lunch box” technique is recognized as the standard for termite testing in Asia-Pacific protocols for evaluating wood protection products.

The “lunch box” consists of a box, pierced at both ends so as to receive a pipe, said box comprising two pieces of wood placed on either side of the pipe and corrugated cardboard in the lower part of the box. One end of said pipe is open and intended for insertion into the termite mound, the other end of the pipe is blind. The pipe, 20 mm in diameter, is pierced with numerous holes 5 mm in diameter so as to allow termites access from the termite mound to the inside of the box. Sand is added to the box so as to attract termites, and the sand is covered with a sheet of corrugated cardboard (top layer). The wood is impregnated with a mixture of hazelnut tree, arnica and oregano extracts.

12 lunch boxes were tested. 6 were treated, 6 were control lunch boxes. 6 lunch boxes, 3 treated and 3 untreated, were placed on one termite mound. The other 6 were placed on another termite mound. The control boxes were impregnated with water.

### Inspection

After 5 weeks, the lunch boxes were inspected. It could be seen that some boxes contained a dark sludge corresponding to the termites' exploration of the wood test specimen. The termites in effect bring their soil/mud to fill the space. This termite exploration confirmed that each “lunch box” was accessible to the termites.

The lunch boxes were opened and the wood inspected, as listed in the table below:

TABLE 3

| “Lunch box” | | Results |
|---|---|---|
| number | Treatment | Inspection after 5 weeks |
| 1 | Control | The termites entered the |
| | | “lunch box”. The wood |
| | | was affected and damaged. |
| 2 | Control | The termites entered the |
| | | “lunch box”. The wood |
| | | was affected and damaged. |
| 3 | Hazelnut tree extract/ | The termites entered the |
| | arnica extract/oregano | “lunch box”. The wood |
| | extract | was not affected. |
| 4 | Control | The termites entered the |
| | | “lunch box”. The wood |
| | | was affected and damaged. |
| 5 | Hazelnut tree extract/ | The termites entered the |
| | arnica extract/oregano | “lunch box”. The wood |
| | extract | was not affected. |
| 6 | Control | The termites entered the |
| | | “lunch box”. The wood |
| | | was affected and damaged. |
| 7 | Control | The termites entered the |
| | | “lunch box”. The wood |
| | | was affected and damaged. |
| 8 | Hazelnut tree extract/ | The termites entered the |
| | arnica extract/oregano | “lunch box”. The wood |
| | extract | was not affected. |
| 9 | Control | The termites entered the |
| | | “lunch box”. The wood |
| | | was affected and damaged. |
| 10 | Hazelnut tree extract/ | The termites entered the |
| | arnica extract/oregano | “lunch box”. The wood |
| | extract | was not affected. |
| 11 | Hazelnut tree extract/ | The termites entered the |
| | arnica extract/oregano | “lunch box”. The wood |
| | extract | was not affected. |
| 12 | Hazelnut tree extract/ | The termites entered the |
| | arnica extract/oregano | “lunch box”. The wood |
| | extract | was not affected. |

* termites stopped just after the top layer of corrugated cardboard.

The test demonstrated that a mixture of hazelnut tree extract, arnica extract and oregano extract allowed wood to be protected from termite attack. Thus, wood treated by impregnation with a mixture of hazelnut tree, arnica and oregano extract is termite-resistant.

### Example 3: Determination of the Efficacy Threshold against Reticulitermes santonensis De Feytaud According to the Standard NF EN 117 (2012)—Wood Protection

During its lifetime, wood treated with a protection product may be exposed to conditions that may cause the wood protection product to evaporate and disappear, thus reducing its efficacy. The standard NF EN 73 (2014) provides a method for laboratory aging of specimens, which are subjected to biological tests.

### Materials and Methods According to the Standard NF EN 73 (2014)

Some of the test specimens used in the example below, in accordance with the NF EN 117 standard, underwent accelerated aging prior to this test, according to the standard NF EN 73 (2014). According to this standard, test specimens are prepared for insect bioassays using appropriate normalizing methods. The test specimens are exposed, for a specified time, to a dust-free air stream of defined velocity and temperature.

Subsequently, the example was performed according to the laboratory test method of the standard NF EN 117 (2012), which provides a basis for assessing the efficacy of a wood protection product against European termite species of the genus Reticulitermes. It enables determination of the concentration above which the product prevents all attack by this insect on impregnated wood of sensitive species.

### Materials and Methods According to the Standard NF EN 117 (2012)

### Principle

Impregnation of several series of test specimens of wood of a susceptible species with a series of solutions whose protection product concentrations range according to a defined progression.

Exposure of these test specimens to specific colonies of Reticulitermes and evaluation of the attack suffered after exposure under defined conditions and after a defined period of time.

Comparison of these results with those obtained with untreated test specimens and control specimens treated with the solvent or diluent. Deduction of the efficacy threshold of the test product.

The test was performed under the conditions and according to the materials and methods of the standard NF EN 117 (2012).

### Extracts

The extracts used are hazelnut tree (5%) or arnica (5%) extracts dissolved in propylene glycol (95%).

### Wood Species

The reference species is Scots pine (Pinus sylvestris Linnaeus).

### Termites

The termites are Reticulitermes santonensis De Feytaud. 250 workers, 3 soldiers and 5 nymphs.

### Dilutions

Hazelnut tree extracts were diluted in 99.0% ethanol. Several concentrations of hazelnut tree extract were tested.

Arnica extracts were diluted in 99.0% ethanol. Several concentrations of arnica extract were tested.

### Number of Test Specimens and Distribution

a) treated test specimens: impregnated specimens subjected to Reticulitermes attack; 5 treated specimens for each product concentration;
b) untreated control specimens to check the virulence of termites collected for the test: these non-impregnated specimens are subjected to Reticulitermes attack; there are 3 of them;
c) control specimens treated with solvent or diluent and subjected to Reticulitermes attack; there are 3 of these.

Test duration: 8 weeks

### Expressing the Results

Record the results of the visual examination.

Also note the survival rate of workers and, where appropriate, the presence of live soldiers and/or nymphs at the end of the test.

The efficacy threshold of a protection product is between the two limit values corresponding to:
the lowest concentration protecting the wood, i.e. the concentration for which none of the 5 test specimens shows an attack higher than level 2, with only one test specimen showing a level 2 attack.
the next lowest concentration in the series for which the wood is no longer sufficiently protected, i.e. the concentration for which at least two test specimens show an attack of level 2 or higher.

Express the efficacy threshold by these limit values in kilograms of product per cubic meter of wood; also indicate the corresponding concentrations of the protection product in the solvent or diluent.

### Evaluation Criteria

The visual evaluation criteria according to the standard EN: 117 (2013) are as follows:
0: no attack
1: attempted attack
2: mild attack
3: moderate attack
4: severe attack

### Results

### Hazelnut Tree Extract—Pre-Aging of Test Specimens According to the Standard NF EN 73 (2014)

The results relating to hazelnut tree extract are presented in Table 4 below. The test specimens underwent accelerated aging beforehand.

TABLE 4

| | Retention | | | | Visual |
|---|---|---|---|---|---|
| Test product | Test | Surviving termites | | | assessment |
| concentration | product | Workers | Soldiers | Nymphs | of test |
| % (w/w) | kg/m³ | % | Number | Number | specimens |
| 0.0 | 0 | 68 | 3 | 5 | 4 |
| Solvent | | 0** | 0** | 0** | 1** |
| | | 51 | 3 | 5 | 4 |
| Concentration | 335 | 0 | 0 | 0 | 0 |
| 1 | | 0 | 0 | 0 | 1 |
| | | 0 | 0 | 0 | 1 |
| | | 0 | 0 | 0 | 1 |
| | | 0 | 0 | 0 | 2 |
| Concentration | 368 | 0 | 0 | 0 | 1 |
| 2 | | 0 | 0 | 0 | 1 |
| | | 0 | 0 | 0 | 1 |
| | | 0 | 0 | 0 | 2 |
| | | 0 | 0 | 0 | 2 |
| Concentration | 383 | 0 | 0 | 0 | 2 |
| 3 | | 0 | 0 | 0 | 1 |
| | | 0 | 0 | 0 | 1 |
| | | 0 | 0 | 0 | 1 |
| | | 0 | 0 | 0 | 1 |
| Concentration | 412 | 0 | 0 | 0 | 1 |
| 4 | | 0 | 0 | 0 | 1 |
| | | 0 | 0 | 0 | 1 |
| | | 0 | 0 | 0 | 1 |
| | | 0 | 0 | 0 | 2 |
| Concentration | 451 | 0 | 0 | 0 | 1 |
| 5 | | 0 | 0 | 0 | 2 |
| | | 0 | 0 | 0 | 1 |
| | | 0 | 0 | 0 | 1 |
| | | 0 | 0 | 0 | 1 |
| Controls | — | 61 | 3 | 5 | 4 |
| | | 52 | 3 | 5 | 4 |
| | | 0** | 0** | 0** | 2** |

**molt developed in the test specimen.

### Hazelnut Tree Extract—Without Prior Aging of Test Specimens

The results relating to hazelnut tree extract are presented in Table 5 below. The test specimens did not undergo accelerated aging.

TABLE 5

| | Retention | | | | Visual |
|---|---|---|---|---|---|
| Test product | Test | Surviving termites | | | assessment |
| concentration | product | Workers | Soldiers | Nymphs | of test |
| % (w/w) | kg/m³ | % | Number | Number | specimens |
| 0.0 | 0 | 63 | 3 | 5 | 4 |
| Solvent | | 65 | 3 | 5 | 4 |
| | | 80 | 3 | 4 | 4 |
| Concentration | 333 | 0 | 0 | 0 | 2 |
| 1 | | 0 | 0 | 0 | 1 |
| | | 0 | 0 | 0 | 1 |
| | | 0 | 0 | 0 | 1 |
| | | 0 | 0 | 0 | 1 |
| Concentration | 368 | 0 | 0 | 0 | 2 |
| 2 | | 0 | 0 | 0 | 1 |
| | | 0 | 0 | 0 | 2 |
| | | 0 | 0 | 0 | 1 |
| | | 0 | 0 | 0 | 1 |
| Concentration | 383 | 0 | 0 | 0 | 2 |
| 3 | | 0 | 0 | 0 | 2 |
| | | 0 | 0 | 0 | 1 |
| | | 0 | 0 | 0 | 2 |
| | | 0 | 0 | 0 | 2 |
| Concentration | 418 | 0 | 0 | 0 | 2 |
| 4 | | 0 | 0 | 0 | 2 |
| | | 0 | 0 | 0 | 1 |
| | | 0 | 0 | 0 | 2 |
| | | 0 | 0 | 0 | 2 |
| Concentration | 453 | 0 | 0 | 0 | 1 |
| 5 | | 0 | 0 | 0 | 2 |
| | | 0 | 0 | 0 | 1 |
| | | 0 | 0 | 0 | 1 |
| | | 0 | 0 | 0 | 1 |
| Controls | — | 63 | 2 | 3 | 4 |
| | | 56 | 1 | 5 | 4 |
| | | 80 | 3 | 4 | 4 |

** molt developed in the test specimen.

The hazelnut tree extract according to the invention effectively protects wood specimens against Reticulitermes attack, whether or not these specimens have undergone premature aging.

### Arnica Extract—Pre-Aging of Test Specimens According to the Standard NF EN 73 (2014)

The results relating to arnica extract are presented in Table 6 below. The test specimens underwent accelerated aging beforehand.

TABLE 6

| | Retention | | | | Visual |
|---|---|---|---|---|---|
| Test product | Test | Surviving termites | | | assessment |
| concentration | product | Workers | Soldiers | Nymphs | of test |
| % (w/w) | kg/m³ | % | Number | Number | specimens |
| 0.0 | 0 | 0** | 0** | 0** | 4 |
| Solvent | | 76 | 3 | 5 | 4 |
| | | 73 | 3 | 5 | 4 |
| Concentration | 78 | 0 | 0 | 0 | 3 |
| 1 | | 0 | 0 | 0 | 3 |
| | | 0 | 0 | 0 | 2 |
| | | 0 | 0 | 0 | 2 |
| | | 0 | 0 | 0 | 3 |
| Concentration | 162 | 0 | 0 | 0 | 2 |
| 2 | | 0 | 0 | 0 | 2 |
| | | 32 | 3 | 1 | 3 |
| | | 0 | 0 | 0 | 2 |
| | | 0 | 0 | 0 | 2 |
| Concentration | 247 | 0 | 0 | 0 | 1 |
| 3 | | 0 | 0 | 0 | 2 |
| | | 0 | 0 | 0 | 1 |
| | | 0 | 0 | 0 | 1 |
| | | 0 | 0 | 0 | 1 |
| Concentration | 305 | 0 | 0 | 0 | 1 |
| 4 | | 0 | 0 | 0 | 1 |
| | | 0 | 0 | 0 | 1 |
| | | 0 | 0 | 0 | 1 |
| | | 0 | 0 | 0 | 2 |
| Concentration | 332 | 0 | 0 | 0 | 2 |
| 5 | | 0 | 0 | 0 | 1 |
| | | 0 | 0 | 0 | 3 |
| | | 0 | 0 | 0 | 2 |
| | | 0 | 0 | 0 | 2 |
| Controls | — | 70 | 3 | 5 | 4 |
| | | 66 | 3 | 3 | 4 |
| | | 77 | 3 | 5 | 4 |

**molt developed in the test specimen.

### Arnica Extract—Without Prior Aging

The results relating to arnica extract are presented in Table 7 below. The test specimens underwent accelerated aging beforehand.

TABLE 7

| | Retention | | | | Visual |
|---|---|---|---|---|---|
| Test product | Test | Surviving termites | | | assessment |
| concentration | product | Workers | Soldiers | Nymphs | of test |
| % (w/w) | kg/m³ | % | Number | Number | specimens |
| 0.0 | 0 | 76 | 3 | 5 | 4 |
| Solvent | | 57 | 2 | 5 | 4 |
| | | 55 | 1 | 5 | 4 |
| Concentration | 78 | 0 | 0 | 0 | 2 |
| 1 | | 0 | 0 | 0 | 3 |
| | | 0 | 0 | 0 | 2 |
| | | 0 | 0 | 0 | 2 |
| | | 0 | 0 | 0 | 3 |
| Concentration | 162 | 0 | 0 | 0 | 2 |
| 2 | | 0 | 0 | 0 | 1 |
| | | 0 | 0 | 1 | 1 |
| | | 0 | 0 | 0 | 2 |
| | | 0 | 0 | 0 | 1 |
| Concentration | 241 | 0 | 0 | 0 | 1 |
| 3 | | 0 | 0 | 0 | 2 |
| | | 0 | 0 | 0 | 1 |
| | | 0 | 0 | 0 | 1 |
| | | 0 | 0 | 0 | 1 |
| Concentration | 302 | 0 | 0 | 0 | 1 |
| 4 | | 0 | 0 | 0 | 2 |
| | | 0 | 0 | 0 | 1 |
| | | 0 | 0 | 0 | 1 |
| | | 0 | 0 | 0 | 1 |
| Concentration | 332 | 0 | 0 | 0 | 2 |
| 5 | | 0 | 0 | 0 | 1 |
| | | 0 | 0 | 0 | 1 |
| | | 0 | 0 | 0 | 1 |
| | | 0 | 0 | 0 | 1 |
| Controls | — | 70 | 3 | 5 | 4 |
| | | 72 | 3 | 5 | 4 |
| | | 66 | 3 | 5 | 4 |

** molt developed in the test specimen.

The arnica extract according to the invention effectively protects wood specimens against Reticulitermes attack, whether or not these specimens have undergone premature aging.

### Example 4: Determination of the Efficacy Threshold Against Hylotrupes bajulus (Linnaeus) Larvae According to the Standard NF EN 47 (2005)—Wood Protection

### Materials and Methods According to the standard NF EN 47 (2005)

### Principle

Standard NF EN 47 describes a laboratory test method which provides a basis for general assessment of the efficacy of a wood protection product against Hylotrupes bajulus by determining and comparing, using different categories of larvae, the concentrations at which the product prevents their survival in totally impregnated susceptible wood.

Several series of test specimens of susceptible wood are impregnated with a range of concentrations of the protection product.

Hylotrupes bajulus larvae of a given category are introduced into these test specimens and their survival rate is determined at fixed time intervals.

The results are compared with those obtained with untreated control test specimens and solvent or diluent control test specimens. The efficacy threshold of the test product for the category of larvae under consideration is then deduced.

The test was performed under the conditions and according to the materials and methods described in the standard NF EN 47 (2005).

### Larvae

Hylotrupes bajulus (Linnaeus) larvae.

### Extracts

The extracts used are hazelnut tree (5%) or arnica (5%) extracts dissolved in propylene glycol (95%).

### Wood Species

The reference species is Scots pine (Pinus sylvestris Linnaeus).

### Dilutions

Hazelnut tree extracts were diluted in 99.0% ethanol. Several concentrations were tested.

Arnica extracts were diluted in 99.0% ethanol. Several concentrations were tested.

### Test Duration

12 weeks, for testing of the test specimens with accelerated aging;
24 weeks, for testing of the test specimens without accelerated aging.

### Examination

After 4 weeks, cut up the test specimens corresponding to the highest concentration. If all the larvae have died, cut up the test specimen series at the next highest concentration, and so on until a concentration is found at which the first living larva is found in a test specimen. Keep the remaining test specimens treated at this concentration, and also those treated at the lower concentrations, for a further 8 weeks.

Then resume cutting up the treated test specimens. For test specimens containing larvae, if a live larva is found, stop this second cutting and keep the remaining treated test specimens for a further 12 weeks, on conclusion of which all the remaining test specimens are cut up.

At the end of the test period, cut up all the control test specimens.

### Expressing the Results

For each exposure period, record the number of larvae having bored into the treated and control test specimens, and also the number of surviving larvae.

The efficacy threshold of a protection product is denoted by the following two concentrations:
the lowest concentration at which no adults emerge and all the larvae are dead by the end of the test:
the next lowest concentration in the series used, at which some adults emerge or larvae are alive at the end of the test.
   Express these values in kilograms of protection product per cubic meter of treated wood, and also indicate the corresponding concentrations of product in the solvent or diluent.

### Results

### Hazelnut Tree Extract—Pre-Aging of Test Specimens According to the Standard NF EN 73 (2014)

The results relating to hazelnut tree extract are presented in Table 8 below. The test specimens underwent accelerated aging according to the criteria of the standard EN 73 (2014) as described above.

TABLE 8

| | Average | Number of larvae | | | |
|---|---|---|---|---|---|
| | retention of | Dead | | | |
| Test product | protection | Not | | | Not |
| concentration | product | bored | Bored | Alive | found |
| % (w/w) | [kg/m³] | [n] | [n] | [n] | [n] |

Examination after 4 weeks

| | | | | | |
|---|---|---|---|---|---|
| Concentration 1 | 238 | 0 | 30 | 0 | 0 |
| Concentration 2 | 157 | 0 | 3 | 1 ^{a)} | 0 |

Examination after 12 weeks

| | | | | | |
|---|---|---|---|---|---|
| Concentration 2 | 157 | 0 ^{b)} | 26 ^{b)} | 0 ^{b)} | 0 ^{b)} |
| Concentration 3 | 97 | 0 | 30 | 0 | 0 |
| Concentration 4 | 60 | 1 | 29 | 0 | 0 |
| Concentration 5 | 30 | 1 | 29 | 0 | 0 |
| 0.0ₑₜₕₐₙₒₗ | 0 | 1 | 0 | 29 | 0 |
| 0control | — | 1 | 0 | 29 | 0 |

^{a)} no further separation
^{b)} with reference to the remaining test specimens

### Hazelnut Tree Extract—Without Prior Aging

The results relating to hazelnut tree extract are presented in Table 9 below. The test specimens did not undergo accelerated aging.

TABLE 9

| | Average | Number of larvae | | | |
|---|---|---|---|---|---|
| | retention of | Dead | | | |
| Test product | protection | Not | | | Not |
| concentration | product | bored | Bored | Alive | found |
| % (w/w) | [kg/m³] | [n] | [n] | [n] | [n] |

Examination after 4 weeks

| | | | | | |
|---|---|---|---|---|---|
| Concentration 1 | 54 | 0 | 27 | 0 | 3 |
| Concentration 2 | 43 | 0 | 27 | 1 ^{a)} | 1 |

Examination after 12 weeks

| | | | | | |
|---|---|---|---|---|---|
| Concentration 2 | 43 | 0 ^{b)} | 25 ^{b)} | 0 ^{b)} | 1 ^{b)} |
| Concentration 3 | 32 | 0 | 10 | 19 | 1 |
| Concentration 4 | 22 | 0 | 3 | 1 ^{a)} | 0 |

Examination after 24 weeks

| | | | | | |
|---|---|---|---|---|---|
| Concentration 4 | 22 | 0 ^{b)} | 25 ^{b)} | 0 ^{b)} | 1 ^{b)} |
| Concentration 5 | 11 | 0 | 10 | 19 | 1 |
| 0.0ₑₜₕₐₙₒₗ | 0 | 1 | 1 | 28 | 0 |
| 0control | — | 1 | 0 | 29 | 0 |

^{a)} no further separation
^{b)} with reference to the remaining test specimens

The hazelnut tree extract according to the invention effectively protects wood specimens against Hylotrupes bajulus attack, whether or not these specimens have undergone premature aging.

### Arnica Extract—Pre-Aging of Test Specimens According to the Standard NF EN 73 (2014)

The results relating to arnica extract are presented in Table 10 below. The test specimens underwent accelerated aging according to the criteria of the standard EN 73 (2014) as described above.

TABLE 10

| | Average | Number of larvae | | | |
|---|---|---|---|---|---|
| | retention of | Dead | | | |
| Test product | protection | Not | | | Not |
| concentration | product | bored | Bored | Alive | found |
| % (w/w) | [kg/m³] | [n] | [n] | [n] | [n] |

Examination after 4 weeks

| | | | | | |
|---|---|---|---|---|---|
| Concentration 1 | 84 | 0 | 0 | 1 ^{a)} | 0 |

Examination after 12 weeks

| | | | | | |
|---|---|---|---|---|---|
| Concentration 1 | 84 | 0 ^{b)} | 29 ^{b)} | 0 ^{b)} | 0 ^{b)} |
| Concentration 2 | 67 | 1 | 29 | 0 | 0 |
| Concentration 3 | 50 | 0 | 30 | 0 | 0 |
| Concentration 4 | 34 | 0 | 30 | 0 | 0 |
| Concentration 5 | 16 | 0 | 6 | 1 ^{a)} | 0 |

Examination after 24 weeks

| | | | | | |
|---|---|---|---|---|---|
| Concentration 5 | 16 | 1 ^{b)} | 19 ^{b)} | 2 ^{b)} | 1 ^{b)} |
| 0.0ₑₜₕₐₙₒₗ | 0 | 1 | 0 | 29 | 0 |
| 0control | — | 1 | 0 | 28 | 0 |

^{a)} no further separation
^{b)} with reference to the remaining test specimens

### Arnica Extract—Without Prior Aging

The results relating to hazelnut tree extract are presented in Table 11 below. The test specimens did not undergo accelerated aging.

TABLE 11

| | Average | Number of larvae | | | |
|---|---|---|---|---|---|
| | retention of | Dead | | | |
| Test product | protection | Not | | | Not |
| concentration | product | bored | Bored | Alive | found |
| % (w/w) | [kg/m³] | [n] | [n] | [n] | [n] |

Examination after 4 weeks

| | | | | | |
|---|---|---|---|---|---|
| Concentration 1 | 84 | 0 | 6 | 1 ^{a)} | 0 |

Examination after 12 weeks

| | | | | | |
|---|---|---|---|---|---|
| Concentration 1 | 84 | 0 ^{b)} | 23 ^{b)} | 0 ^{b)} | 0 ^{b)} |
| Concentration 2 | 66 | 0 | 29 | 0 | 1 |
| Concentration 3 | 50 | 1 | 28 | 0 | 1 |
| Concentration 4 | 34 | 0 | 28 | 0 | 2 |
| Concentration 5 | 17 | 0 | 2 | 1 ^{a)} | 0 |

Examination after 24 weeks

| | | | | | |
|---|---|---|---|---|---|
| Concentration 5 | 17 | 0 ^{b)} | 21 ^{b)} | 5 ^{b)} | 1 ^{b)} |
| 0.0ₑₜₕₐₙₒₗ | 0 | 1 | 0 | 27 | 3 |
| 0control | — | 1 | 0 | 29 | 1 |

^{a)} no further separation
^{b)} with reference to the remaining test specimens

The hazelnut tree extract according to the invention effectively protects wood specimens against Hylotrupes bajulus attack, whether or not these specimens have undergone premature aging.

### Example 5: Preventive Wood Pest Control Action of Extracts According to the Invention Against Termites

### Testing in Residential Houses

In the following example, baits in the form of a strip of wood having the following dimensions are tested: 5×2.5×18.5 cm. The baits were tested against Asian subterranean termites Coptotermes gestroi. The test comprises three phases: monitoring, poisoning and control.

### Monitoring

Two residential houses (House A and House B) with an active colony of subterranean termites (C. gestroi) were used as test sites. The houses are located in Indonesia.

Initially, several monitoring stations were set up in these houses by placing moistened tissue paper in boxes comprising the bait in areas of active termite infestation (two months).

The monitoring stations were regularly inspected to check for termite colony activity and termite infestation in the field. If active infestation of termites was confirmed at the monitoring stations, the test was launched.

### Bait Poisoning

Test set-up: each house was composed of two stations:
(a) a baiting station, in which four pieces of wood were placed inside the bait box station and completely covered with black adhesive tape. The pieces of wood are impregnated with a mixture of an arnica extract (⅓), a hazelnut tree extract (⅓) and an oregano extract (⅓), the extracts being in solution in propylene glycol, the sum of the contents of the extracts being equal to 5% of the total weight of the composition.
(b) a control station, in which moistened tissue papers were placed in the plastic box stations and covered with black adhesive tape. The control station allows the activity of the termite colony to be monitored during the test.

### Control

The stations were observed once a week so as to evaluate termite presence, attack and bait consumption.

The tests were performed over a three-month period.

During the test period, continuous observations were performed to evaluate the elimination of the targeted termite colony.

At the end of the test, the stations were thoroughly inspected to verify the elimination of the termite colonies.

In the case where the colony was successfully exterminated, monitoring was continued for a further three months, with at least three inspections to detect any new infestation.

### Results

The results of weekly monitoring of the baiting and control stations in houses A and B are shown in Table 12. The results are the same for both houses.

TABLE 12

| Observation | | |
|---|---|---|
| period | Results | |
| Week | Baiting station | Control station |
| 1 | No termite attack | Attack of damp tissue paper by |
| | | termites and replacement of the |
| | | tissue paper. |
| 2 | No termite attack | Attack of damp tissue paper by |
| | | termites and replacement of the |
| | | tissue paper. |
| 3 | No termite attack | Attack of damp tissue paper by |
| | | termites and replacement of the |
| | | tissue paper. |
| 4 | No termite attack | Attack of damp tissue paper by |
| | | termites and replacement of the |
| | | tissue paper. |
| 5 | No termite attack | Attack of damp tissue paper by |
| | | termites and replacement of the |
| | | tissue paper. |
| 6 | No termite attack | Attack of damp tissue paper by |
| | | termites and replacement of the |
| | | tissue paper. |
| 7 | No termite attack | Attack of damp tissue paper by |
| | | termites and replacement of the |
| | | tissue paper. |
| 8 | No termite attack | Attack of damp tissue paper by |
| | | termites and replacement of the |
| | | tissue paper. |
| 9 | No termite attack | Attack of damp tissue paper by |
| | | termites and replacement of the |
| | | tissue paper. |
| 10 | No termite attack | Attack of damp tissue paper by |
| | | termites and replacement of the |
| | | tissue paper. |
| 11 | No termite attack | Attack of damp tissue paper by |
| | | termites and replacement of the |
| | | tissue paper. |
| 12 | No termite attack | Attack of damp tissue paper by |
| | | termites and replacement of the |
| | | tissue paper. |
| 13 | No termite attack | Attack of damp tissue paper by |
| | | termites and replacement of the |
| | | tissue paper. |
| 14 | No termite attack. | Active termite colony - |
| | Termite colonies | end of test |
| | not eliminated | |

Baits comprising an extract according to the invention are effective repellents and allow preventive treatment of wood. Thus, wood treated by impregnation with extracts according to the invention is advantageously termite-resistant.

### Test at a Forestry Research Station in Indonesia

For the results below, the baits were installed at a forestry research station in Indonesia.

### Monitoring

Initially, several monitoring stations were set up at these locations by placing untreated virgin wooden stakes manufactured from rubber wood with a dimension of 2×2×30 cm in the ground (about two months).

The monitoring stations were regularly inspected for termite colony activity and termite infestation on the virgin wooden stakes.

If active termite infestation was confirmed at the monitoring stations, testing was launched.

### Poisoning

Test set-up: Each location was composed of two stations:
(a) a baiting station, in which a piece of wood is driven into the ground and covered with a plastic bucket. The piece of wood is impregnated with a mixture of an arnica extract (⅓), a hazelnut tree extract (⅓) and an oregano extract (⅓), the extracts being in solution in propylene glycol, the sum of the contents of the extracts being equal to 5% of the total weight of the composition.
(b) a control station. The control station allows the activity of the termite colony to be monitored during the test.

In total, four stations were installed at different locations (two baiting stations and two control stations).

### Control

The stations were observed once a week so as to evaluate termite presence, attack and bait consumption.

The tests were performed over a three-month period.

During the test period, continuous observations were performed to evaluate the elimination of the targeted termite colony.

At the end of the test, the stations were thoroughly inspected to verify the elimination of the termite colonies.

In the case where the colony was successfully exterminated, monitoring was continued for a further three months, with at least three inspections to detect any new infestation.

### Results

The results of weekly monitoring of the baiting and control stations are shown in Table 13.

TABLE 13

| Observation | | | | |
|---|---|---|---|---|
| period | Results | | | |
| Week | Baiting station | Control station | Baiting station | Control station |
| 1 | No termite | Termite attack/ | No termite | Termite attack |
| | attack | replacement of | attack | |
| | | the stake | | |
| 2 | No termite | Termite attack/ | No termite | Replacement of |
| | attack on bait 1 | replacement of | attack | the stake |
| | Trace of termite | the stake | | |
| | attack on bait 2 | | | |
| 3 | No termite | Termite attack | No termite | Termite attack |
| | attack | | attack | |
| 4 | No termite | Replacement of | No termite | Replacement of |
| | attack | the stake | attack | the stake |
| 5 | No termite | Termite attack | No termite | Termite attack |
| | attack | | attack | |
| 6 | No termite | Replacement of | No termite | Replacement of |
| | attack | the stake | attack | the stake |
| 7 | No termite | Termite attack | No termite | Termite attack |
| | attack | | attack | |
| 8 | No termite | Replacement of | No termite | Replacement of |
| | attack | the stake | attack | the stake |
| 9 | No termite | Termite attack | No termite | Termite attack |
| | attack | | attack | |
| 10 | No termite | Replacement of | No termite | Replacement of |
| | attack | the stake | attack | the stake |
| 11 | No termite | Termite attack | No termite | Termite attack |
| | attack | | attack | |
| 12 | No termite | Replacement of | No termite | Replacement of |
| | attack | the stake | attack | the stake |
| 13 | No termite | Termite attack | No termite | Termite attack |
| | attack | | attack | |
| 14 | No termite | Active termite | No termite | Active termite |
| | attack. Termite | colony - end of | attack. Termite | colony - end of |
| | colonies not | test | colonies not | test |
| | eliminated | | eliminated | |

Baits impregnated with an extract according to the invention are effective repellents and allow preventive treatment of wood. Thus, wood treated by impregnation with extracts according to the invention is advantageously termite-resistant.

### Example 6: Evaluation of the Efficacy of Extracts According to the Invention as Insecticides Against Cockroaches

In this example, four active agents were tested to evaluate their efficacy as insecticides against the American cockroach (Periplaneta americana).

### Materials and Methods

The four active agents are as follows:
hazelnut tree extract
arnica extract
oregano extract
a mixture comprising hazelnut tree extract (⅓), arnica extract (⅓) and oregano extract (⅓).

Each active agent was formulated as an emulsion (the active agents were diluted in water), the active agent being present in a content of 10% by weight for the first test and 50% by weight for the second test, relative to the total weight of the emulsion.

The emulsions were applied directly to adult cockroaches.

Arnica extract showed efficacy as an insecticide against cockroaches, and did so from the second to the tenth day.

The mixture of arnica, hazelnut tree and oregano extracts showed efficacy as an insecticide against cockroaches from the ninth day.

No efficacy was obtained with the control.

At 50% concentration, all the extracts showed insecticidal efficacy against cockroaches, and did so from day one, for 10 consecutive days. No efficacy was obtained with the control.

Thus and advantageously, the extracts and a mixture thereof have lethal activity on cockroaches.

### Example 7: Testing the Efficacy and Repellency of Extracts According to the Invention Against Poultry Red Mites

In this example, the aim was to determine the lethal efficacy and repellent potential of extracts according to the invention, suspended in propylene glycol on a 15×15 cm plywood tile, against poultry red mites (Dermanyssus gallinae).

### Materials and Methods

For lethal efficacy (curative treatment), the entire tile was treated, while for repellency (preventive treatment), half the tile was treated with the suspensions. 50 ml/m² of suspensions were applied to each tile.

24 hours after tile treatment, arthropods were exposed to the treated tiles in a continuous manner. To test repellency, arthropods were placed on the untreated part of the tiles. Lethal efficacy and repellent activity were evaluated 4, 8, 24 and 48 hours after insect introduction (at 24-25° C. and a relative humidity content of between 52% and 59%).

Three replications were performed (one for the control).

### Extracts

The extracts are arnica (5%) and hazelnut tree (5%) extracts dissolved in propylene glycol (95%). The control is propylene glycol.

### Results

### Lethal Efficacy (Curative Treatment): Arnica Extract

After 8 hours of exposure, on average over the three replications, there was a 23% “knockdown” and/or mortality rate.

After 24 hours of exposure, on average over the three replications, there was a 40% “knockdown” and/or mortality rate.

After 48 hours of exposure, on average over the three replications, there was a 45% “knockdown” and/or mortality rate.

### Lethal Efficacy (Curative Treatment): Hazelnut Tree Extract

After 8 hours of exposure, on average over the three replications, there was a 3% “knockdown” and/or mortality rate.

After 24 hours of exposure, on average over the three replications, there was an 8% “knockdown” and/or mortality rate.

After 48 hours of exposure, on average over the three replications, there was an 11% “knockdown” and/or mortality rate.

The control treated with propylene glycol reached 10% knockdown and/or mortality at 24 hours and 15% after 48 hours.

### Repellency (Preventive Treatment): Arnica Extract

After 24 hours of exposure, on average over the three replications, 77% of the red mites were found on the untreated part, and 23% on the treated part.

After 48 hours of exposure, on average over the three replications, 62% of the red

mites were found on the untreated part, and 38% on the treated part.

### Repellency (Preventive Treatment): Hazelnut Tree Extract

After 24 hours of exposure, on average over the three replications, 58% of the red mites were found on the untreated part, and 42% on the treated part.

After 48 hours of exposure, on average over the three replications, 63% of the red mites were found on the untreated part, and 37% on the treated part.

For the propylene glycol control, after 24 hours of exposure, 70% of the red mites were found on the untreated part and 30% on the treated part.

After 48 hours of exposure, on average over the three replications, 65% of the red mites were found on the untreated part, and 35% on the treated part.

Advantageously, the arnica and hazelnut tree extracts according to the invention have efficacy in the preventive and curative treatment of poultry red mites.

1. A method of protecting wood, protecting against wood pests, or killing insects, comprising applying to wood or a plant or a substrate or subject a plant extract of the Asteraceae family to provide wood protection or wood pest control or to function as an insecticide.

2. The method as claimed in claim 1, wherein the plant extract from the Asteraceae family is applied in combination with a plant extract from the Betulaceae family and/or a plant extract from the Lamiaceae family.

3. The method of claim 1 wherein the plant extract is applied for protection against or for controlling xylophagous insects and/or xylophagous fungi.

4. The method of claim 3 wherein the xylophagous insects are selected from the group consisting of termites, Coptotermes spp, Prorhinotermes spp, Cryptotermes spp, Heterotermes spp, Nasusitermes spp, Macrotermes spp; Odontermes spp; Schedorhinotermes spp; Microtermes spp, Microcerotermes spp, Allodontermes spp, capricorn beetles, carpenter ants, wood borers, lyctus beetles, fresh wood insects and hesperophanes, and the xylophagous fungi are chosen from the multicolored coloriole (Coriolus versicolor or Trametes versicolor), cellar polypore (Donkiporia), merula and its rhizomorphs (Serpula lacrymans), cellar coniophore (Coniophora puteana), Poria vaporaria, Poria spez, oak lenzite, Gloeophyllum trabeum, and Rhodonia placenta.

5. The method of claim 1 wherein the plant extract provides the function of the insecticide, and wherein the insecticide is insecticidal against insects selected from the group consisting of cockroaches, ants, fleas, bed bugs, wood bugs, woodlice (Porcellio scaber), silverfish, (Lepisma saccharina), flour beetle (Tribolium confusum), little whipworm (Alphitobius spp), yellow whipworm (Tenebrio molitor), carpet beetle (Anthrenus flavipes), spiders, lice, wasps, hornets, flies, bees and moths, Mediterranean flour moth (Ephestia kuehniella), clothes moths, mosquitoes, rice weevil (Sitophilus oryzae), needle moth (Rhizoperta dominica), grain beetle (Sitophilus granarius), Sitophilus zeamais, grain moth (Sitotroga cerealella), Acarus siro, mushroom moth (Tyrophagus putrescentieae), grain beetle (Oryzaephilus surinamensis), flour worm (Tribolium castaneum, Tribolium confusum), Cryptolestes ferrugineus, Tenebroides mauritanicus, dried fruit moth (Plodia interpunctella), and flour moth (Ephestia kuehniella).

6. The method of claim 1 wherein the plant extract provides the function of the insecticide, and wherein the insecticide is insecticidal against cockroaches and lice.

7. The method of claim 1 wherein the plant extract is an extract of arnica (Arnica montana).

8. A wood protection or wood pest control product, comprising
a plant extract that is an extract of arnica (Arnica montana) or an extract of arnica and a hazelnut tree extract (Corylus avellanna),
wherein said plant extract is present in a content of between 0.1% and 5% by weight relative to a total weight of the product.

9. The wood protection or wood pest control product as claimed in claim 8, further comprising an extract of oregano (Origanum vulgare), said extract of oregano being present in the product in a content of between 0.1% and 10% by weight relative to the total weight of the product.

10. The wood protection or wood pest control product as claimed in claim 8 further comprising at least one additional agent selected from the group consisting of chosen from nonionic surfactants, antifoams, anionic surfactants, water-soluble polymers, chelating agents, acids, preserving agents, waxes, waxy emulsions, cationic surfactants, insecticides, plant extracts, antioxidants, fungicides, cellulose ethers, isoalkanes, a mixture of alkoxysilane and disiloxane, luminescent agents, UV additives, tagging agents, and biobased cosolvents.

11. The wood protection or wood pest control product as claimed in claim 8 further comprising at least one isoalkane, at least one cellulose ether, and at least one mixture of alkoxysilane and disiloxane.

12. A curative and/or preventive treatment process for wood protection or wood pest control by a wood protection or wood pest control product comprising at least one plant extract from the Asteraceae family, said process comprising applying said product to the wood to be treated and/or to a surface.

13. A process for the preventive treatment of buildings by a wood pest control product comprising at least one plant extract from the Asteraceae family, said process comprising applying said product to a surface a building or to a film and depositing the film on the surface.

14. An insecticidal or repellent composition comprising
a plant extract comprising an extract of arnica (Arnica montana) or an extract of arnica and a hazelnut tree extract (Corylus avellanna),
wherein the plant extract is present in the composition in a content of between 0.1% and 5% by weight relative to a total weight of the composition.

15. The insecticidal or repellent composition as claimed in claim 14, further comprising an extract of oregano (Origanum vulgare), said extract of oregano being present in the composition in a content of between 0.1% and 10% by weight relative to the total weight of the composition.

16. The insecticidal or repellent composition as claimed in claim 14 further comprising at least one additional agent selected from the group consisting of nonionic surfactants, antifoams, anionic surfactants, water-soluble polymers, chelating agents, acids, preserving agents, waxes, waxy emulsions, cationic surfactants, insecticides, plant extracts, antioxidants, fungicides, cellulose ethers, isoalkanes, a mixture of alkoxysilane and disiloxane, luminescent agents, UV stabilizers, tagging agents, and biobased cosolvents.

17. The insecticidal or repellent composition as claimed in claim 14 further comprising at least one isoalkane, at least one cellulose ether, and at least one mixture of alkoxysilane and disiloxane.

18. The insecticidal or repellent composition as claimed in claim 17, wherein the composition is formulated as an aqueous gel.

19. A process for controlling pests by an insecticidal composition and/or a repellent composition comprising a plant extract from the Asteraceae family, comprising applying said composition(s) to a surface to be treated.

20. The process as claimed in 19 wherein the composition comprises an extract of a plant from the Betulaceae family and/or an extract of a plant from the Lamiaceae family.

21. (canceled)

22. The process as claims in claim 12 wherein the product comprises an extract of a plant from the Asteraceae family and/or an extract of a plant from the Lamiaceae family.

23. The process as claims in claim 13 wherein the product comprises an extract of a plant from the Asteraceae family and/or an extract of a plant from the Lamiaceae family.
